(19) United States
(12) Patent Application Publication
(10) Pub. No.: US 2016/0355126 A1
(43) Pub. Date: Dec. 8, 2016

(54) HELMET WITH INTEGRATED CAMERA AND SAFETY LIGHT SYSTEM INCLUDING SAME

(71) Applicant: Strategic Technology Group LLC, Yorba Linda, CA (US)

(72) Inventors: RC Anderson, La Mesa, CA (US); Kenneth J. Long, La Mesa, CA (US)

(21) Appl. No.: 15/173,371

(22) Filed: Jun. 3, 2016

Related U.S. Application Data
(60) Provisional application No. 62/171,883, filed on Jun. 5, 2015.

(51) Int. Cl. B60Q 7/00; H04N 5/225; A42B 3/04; H04N 5/232

(52) U.S. Cl. CPC B60Q 7/00; H04N 5/23203; H04N 5/2252; A42B 3/042; B60Q 2900/30

(57) ABSTRACT

A helmet adapted to be wearable by an operator of a motor vehicle includes a shell, one or more light-emitting modules associated with the shell, and a controller. The controller is adapted to activate the at least one light-emitting module responsive to a signal indicative of activation of emergency lights on the motor vehicle. A camera module that includes a housing and a camera may be associated with the shell. The controller may be adapted to activate the camera responsive to a signal indicative that the helmet is in proximity to the motor vehicle.

### CROSS-REFERENCE TO RELATED APPLICATIONS

This application relates to and claims the benefit of U.S. Provisional Application No. 62/171,883, filed Jun. 5, 2015 and entitled “HELMET WITH INTEGRATED CAMERA AND SAFETY LIGHT SYSTEM INCLUDING SAME,” the disclosure of which is herein incorporated by reference in its entirety.

### STATEMENT RE: FEDERALLY SPONSORED RESEARCH/DEVELOPMENT

Not Applicable

### BACKGROUND

1. Technical Field

The present disclosure generally relates to protective helmets. More particularly, the present disclosure relates to a helmet with an integrated camera and a safety light system including the same.

2. Discussion of Related Art

Motor vehicle accidents occur every day, resulting in varying degrees of injury or, too often, death. The costs of motor vehicle accidents include property damage, lost earnings, lost household production, medical costs, emergency services, travel delay, vocational rehabilitation, workplace costs, administrative and legal costs, pain and loss of life. The use of protective helmets can minimize the risk of death or permanent impairment.

There is a continuing need for proper safety equipment to improve safety and reduce vehicle-related incidents related to response of vehicular-mounted officers, such as motorcycle-mounted police and highway patrol officers, bicycle-mounted police officers, and horse-mounted police officers.

### BRIEF SUMMARY

Various embodiments of the present disclosure provide a safety light system including a helmet with an integrated camera, a helmet receiver/emergency transmitter operably associated with the helmet, wearable by an operator of a vehicle (e.g., motorcycle, bicycle, powered bicycle, snowmobile, glider, etc.), and a base transmitter/emergency receiver operably associated with the vehicle. The base transmitter/emergency receiver (also referred to herein as the “base transmitter component”) is communicatively coupleable with one or more system components of the vehicle, e.g., an emergency lights switch, and includes a controller configured to receive one or more signals from one or more sensors, buttons, and/or switches associated with the motorcycle, e.g., one or more switches associated with the motorcycle emergency lights module. The helmet receiver/emergency transmitter (also referred to herein as the “helmet receiver system”) includes a controller configured to transmit one or more signals for activating one or more light sources, e.g., light-emitting modules, associated with the helmet. The helmet receiver system may include a (non-removable) internal memory which ensures chain of custody.

According to an aspect of the present disclosure, a helmet adapted to be wearable by an operator of a motor vehicle is provided. The helmet includes a shell, one or more light-emitting modules associated with the shell, and a controller. The controller is adapted to activate the at least one light-emitting module responsive to a signal indicative of activation of emergency lights on the motor vehicle. A camera module that includes a housing and a camera may be associated with the shell. The controller may be adapted to activate the camera responsive to a signal indicative that the helmet is in proximity to the motor vehicle.

According to another aspect of the present disclosure, a safety light system is provided. The safety light system includes: a base transmitter component communicatively coupleable with one or more system components of a motor vehicle, wherein the one or more system components include an emergency lights switch; a helmet adapted to be wearable by a motor vehicle operator; a plurality of light-emitting modules associated with the helmet; a camera module associated with the helmet; and a helmet receiver system. The camera module includes a housing and a camera. The camera module may also include a microphone. The helmet receiver system includes an antenna and a controller adapted to activate one or more of the plurality of light-emitting modules responsive to a signal received from the base transmitter component indicative of activation of the emergency lights switch on the motor vehicle. The controller may be further adapted to activate a camera responsive to a signal indicative that the helmet is in proximity to the motor vehicle.

### BRIEF DESCRIPTION OF THE DRAWINGS

Objects and features of the presently-disclosed helmet with an integrated camera and safety light system including the same will become apparent to those of ordinary skill in the art when descriptions of various embodiments thereof are read with reference to the accompanying drawings, of which:

FIG. 1 is a perspective view of a safety light system including a helmet in accordance with an embodiment of the present disclosure;

FIG. 2 is a front perspective view of the helmet of FIG. 1, showing a camera module and multiple light-emitting modules associated with the helmet, in accordance with an embodiment of the present disclosure;

FIG. 3 is an enlarged perspective view of the camera module of FIG. 2 in accordance with an embodiment of the present disclosure;

FIG. 4 is an enlarged perspective view of the camera module of FIG. 2, showing the camera lens covered, in accordance with an embodiment of the present disclosure;

FIG. 5 is a rear perspective view of the helmet of FIG. 1, showing multiple light-emitting modules associated with the helmet, in accordance with an embodiment of the present disclosure;

FIG. 6 is an enlarged perspective view of the light-emitting module of FIGS. 2 and 5 in accordance with an embodiment of the present disclosure;

FIG. 7 is a functional block diagram of a base transmitter/emergency receiver of the safety light system of FIG. 1 in accordance with an embodiment of the present disclosure;

FIG. 8 is perspective view of a printed circuit board including a microcontroller and an antenna for implementing the base transmitter/emergency receiver of FIG. 7 in accordance with an embodiment of the present disclosure;

FIG. 9 is top perspective view of a helmet, showing a camera module and multiple light-emitting modules associated with the helmet, in accordance with another embodiment of the present disclosure;

FIG. 10 is a bottom side perspective view of the helmet of FIG. 9, showing a helmet receiver/emergency transmitter, in accordance with an embodiment of the present disclosure;

FIG. 11 is a perspective view of a helmet and a helmet liner, shown separated, in accordance with an embodiment of the present disclosure;

FIG. 12 is a bottom perspective view of the helmet of FIG. 11 in accordance with an embodiment of the present disclosure;

FIG. 13 is an enlarged, perspective view of the indicted area of detail of FIG. 12 in accordance with an embodiment of the present disclosure;

FIG. 14 is an enlarged, perspective view of the indicted area of detail of FIG. 12 in accordance with an embodiment of the present disclosure; and

FIG. 15 is a schematic view of a helmet receiver/emergency transmitter e in accordance with an embodiment of the present disclosure.

### DETAILED DESCRIPTION

Hereinafter, embodiments of a helmet with an integrated camera and a safety light system including the same are described with reference to the accompanying drawings. Like reference numerals may refer to similar or identical elements throughout the description of the figures.

This description may use the phrases “in an embodiment,” “in embodiments,” “in some embodiments,” or “in other embodiments,” which may each refer to one or more of the same or different embodiments in accordance with the present disclosure.

As it is used in this description, “portable power source” refers to any portable source of electrical power, e.g., battery or battery pack, portable solar power system, etc. As it is used in this description, “transmission line” generally refers to any transmission medium that can be used for the propagation of signals from one point to another. A transmission line may he, for example, a wire, two or more conductors separated by an insulating medium (two-wire, coaxial, microstrip, etc.), a waveguide, a fiber optic line and/or fiber optic bundles.

As it is used in this description, “printed circuit board” (or “PCB”) generally refers to systems that provide, among other things, mechanical support to electrical devices and/or components, electrical connection to and between these electrical components, combinations thereof, and the like. As used herein, the term “controller” may include any type of computing device, computational circuit, or any type of processor or processing circuit capable of executing a series of instructions that are stored in a memory associated with the controller. As it is used in this description, “storage device” generally refers to any device used to store the recorded data or visual, audio or other images captured by a camera or video capture system.

As it is used in this description, “light-emitting diode” generally refers to any light source that is capable of receiving an electrical signal and producing a color of light in response to the signal. Thus, “light-emitting diode,” as used herein, includes any light source including but not limited to light-emitting diodes (LEDs) of all types and colors, including white LEDs, infrared LEDs, ultraviolet LEDs, green LEDs, violet LEDs, visible color LEDs, light-emitting polymers, semiconductor dies that produce light in response to current, organic LEDs, electro-luminescent strips, silicon based structures that emit light, and other such light sources. As it is used in this description, “color” generally refers to any frequency of electromagnetic radiation, or combination of different frequencies, within the visible light spectrum, the infrared and ultraviolet areas of the spectrum, and in other areas of the electromagnetic spectrum where illumination sources may generate radiation.

he controller associated with the helmet receiver system may include logic, circuitry and/or code adapted to control one or more light-emitting modules (e.g., composed of LEDs, LED tape lighting, LED light strips, fiber optic lighting, chemical lighting, lasers, etc.) for providing police emergency lights (e.g., blue and/or amber lights), e.g., responsive to one or more signals received from the base transmitter component and/or one or more signals from one or more sensors, buttons, and/or switches associated with the helmet. The controller associated with the helmet receiver system may be adapted to provide a “Wig-Wag” pattern that cycles through several different and distinct flash patterns that may include a strobe effect. The controller associated with the helmet receiver system may include logic, circuitry and/or code adapted to control a camera and/or microphone, e.g., responsive to one or more signals received from the base transmitter component and/or one or more signals from one or more sensors, buttons, and/or switches associated with the helmet. The controller associated with the helmet receiver system may additionally, or alternatively, be adapted to activate the camera and/or microphone in response to voice, or recognizable sounds such as a gunshot, explosion, etc., and/or speech, e.g., keywords such as “fire,” “help,” etc., or phrases such as “officer needs assistance,” “officer down,” etc. and/or common commands such as “get down,” “don't move,” etc., and may be configured with speech recognition software for this purpose.

The controller associated with the helmet receiver system may include logic, circuitry and/or code adapted to activate a camera and/or microphone (and/or to activate a cellular phone and/or other communication device to send an alert) responsive to a signal indicative that the law-enforcement officer has withdrawn a service revolver, Taser, handcuffs, etc. from the officer's equipment belt. The controller associated with the helmet receiver system may additionally, or alternatively, include logic, circuitry and/or code adapted to activate a camera and/or microphone responsive to a signal indicative that the officer has activated a body camera. The controller associated with the helmet receiver system may additionally, or alternatively, be adapted to activate a camera and/or microphone (and/or light modules) responsive to a remote signal, e.g., remote signal sent from a dispatch/motorcade official (via the vehicle to the officer's helmet), remote signal sent from a dispatch/motorcade official (via the officer's issued cellular phone), and remote signal sent from an escort vehicle/motorcade official traveling with escort.

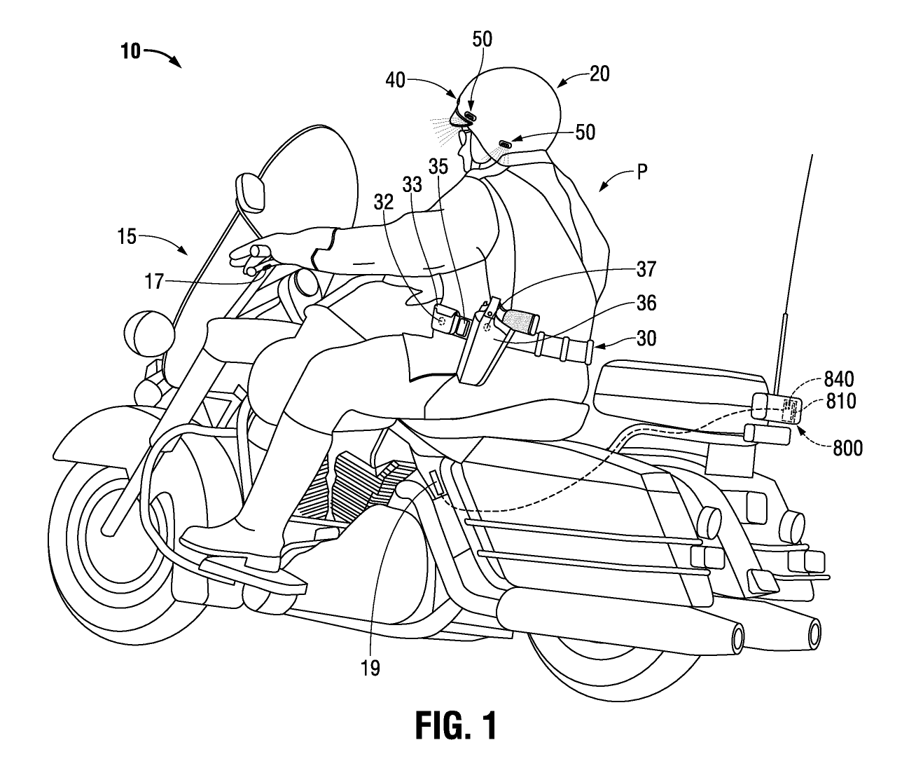

FIG. 1 shows a safety light system 10 that includes a helmet 20 in accordance with an embodiment of the present disclosure. The helmet 20 may be a conventional hard-shell, impact absorbing helmet which preferably provides a user with resistance to head injury due to impact when properly utilized. A camera module 40 is integrated into the helmet 20, e.g., wearable by an operator “P” of the motorcycle 15. Those skilled in the art will recognize that a plurality of camera modules 40 may be associated with the helmet 20. In some embodiments, as shown for example in FIG. 1, the safety light system 10 includes a base transmitter component 800 operably associated with a motorcycle 15. The base transmitter component 800 may additionally, or alternatively, be worn or otherwise carried on or about the person of the operator “P” of the motorcycle 15. In the case of a mounted police officer, one or more base transmitter components 800 may be carried on or about the person of the police officer and/or carried by the officer's equine partner, e.g., carried on the equestrian saddle.

The base transmitter component 800 (also referred to herein as “base transmitter/emergency receiver 800”) includes an antenna 810. Those skilled in the art will recognize that the location of the base transmitter component 800 may be varied from the configuration depicted in FIG. 1. The base transmitter component 800 may be removable from the motorcycle 15, or integrally formed into one or more components of the motorcycle 15. In some embodiments, wherein the base transmitter component 800 is a separate component, a bracket, clamp, or other fastener may be provided for removably attaching the base transmitter component 800 to the motorcycle 15 (or bicycle, powered bicycle, snowmobile, etc.).

In some embodiments, for example as shown in FIG. 1, the base transmitter component 800 is coupled to an emergency lights switch 17 on the motorcycle 15, via a transmission line (as indicated by the dashed line in FIG. 1) connected to an appropriate wired relay in a fuse box 19 associated with the motorcycle 15. Additionally, or alternatively, a wired connection may be provided between the base transmitter component 800 and the vehicle's brake lights or other lights (e.g., aftermarket lights) associated with the vehicle. In some embodiments, wherein a transmitter is operably associated with the vehicle emergency lights module, the base transmitter component 800 may be adapted to receive wireless signals indicative that the vehicle emergency lights (and/or other component of the vehicle) have been activated. It is to be understood that the dashed lines indicative of electrical connections (e.g., electrical conductors) between various components of the safety light system 10 are merely illustrative and non-limiting examples of electrical connections, and that safety light system embodiments of the present disclosure may utilize many different configurations of electrical connections, some with additional, fewer, or different electrical connections than depicted in FIG. 1.

In some embodiments, the base transmitter component 800 may include an accelerometer 840. As is well known, during collisions, vehicles are rapidly decelerated due to the impact forces. The accelerometer 840 may be used to detect rapid deceleration that is indicative of a collision and the controller (e.g., microcontroller 820 as shown in FIG. 8) may be configured to send a camera activation signal to the helmet 20 and/or to activate a cellular phone (and/or other communication device) to send an alert. Additionally, or alternatively, the controller associated with the base transmitter component 800 may be configured to receive an emergency impact signal from the helmet 20, and may be configured to activate a cellular phone (and/or other communication device) to send an alert.

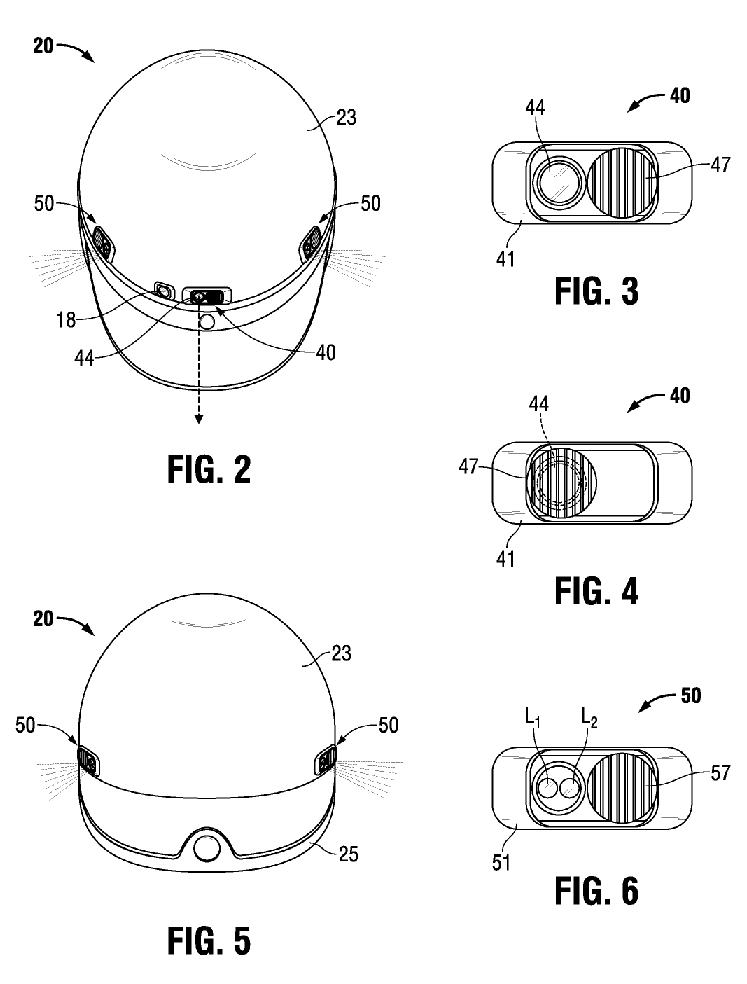

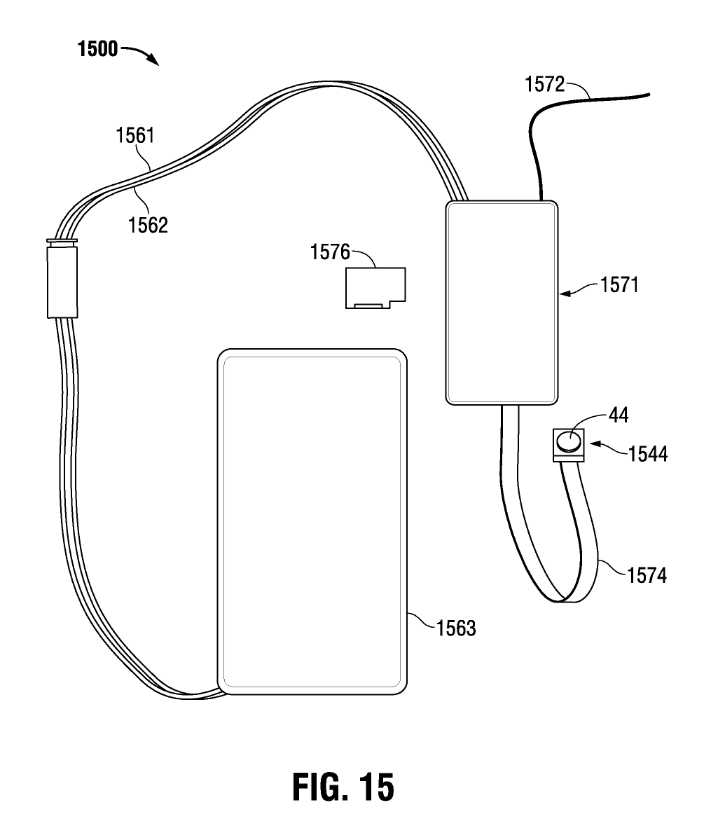

Integrated into or otherwise associated with the helmet 20 is a helmet receiver system (e.g., helmet receiver system 1500 shown in FIG. 15). The helmet 20 may include one or more light sources, e.g., light-emitting modules 50. The light-emitting modules 50 may include one or more lighting devices (e.g., LEDs, flexible LED strip lights, LED tape, fiber optic lighting, chemical lighting, lasers, etc.). In the illustrative embodiment shown in FIG. 2, a camera module 40 is centrally located at the front portion of the helmet 20 and two light-emitting modules 50 are disposed in spaced apart relation to the camera module 40 on the opposing sides of the helmet. In some embodiments, a rear camera module 40, a front camera module 40, a left-side camera module 40 and/or a right-side camera module 40 may be integrated into or otherwise associated with the helmet 20.

As illustratively depicted in FIG. 1, the equipment belt 30 worn by the operator “P” includes a control unit 35, which may be coupled to a sensor 37 operably associated with a holster 36 and a sensor 32 operably associated with a pouch 33 for handcuffs (or other item). In some embodiments, wherein the safety light system 10 is adapted to receive signals from the control unit 35, the controller associated with the helmet receiver system may include logic, circuitry and/or code adapted to activate a camera and/or microphone (and/or to activate a cellular phone and/or other communication device to send an alert) responsive to a signal transmitted from the control unit 35 indicative that the operator “P” (e.g., law-enforcement officer) has drawn a service revolver (or Taser) from the holster 36 or handcuffs (or other item) from the pouch 33 associated with the equipment belt 30.

In FIGS. 3 and 4, an embodiment of the camera module 40 is shown and includes a housing 41, a camera lens 44 associated with a camera (e.g., 1544 as shown in FIG. 15), and a cover element 47 slidably coupled to the housing 41. The cover element 47 is adapted to be selectively slidable between a first position, wherein the camera lens 44 is not covered, e.g., as shown in FIG. 3, and a second position, wherein the camera lens 44 is covered by the cover element 47, e.g., as shown in FIG. 4. The cover element 47 may include ergonomic features such as ridges as part of the outer surface thereof to facilitate gripping by a fingertip or thumb.

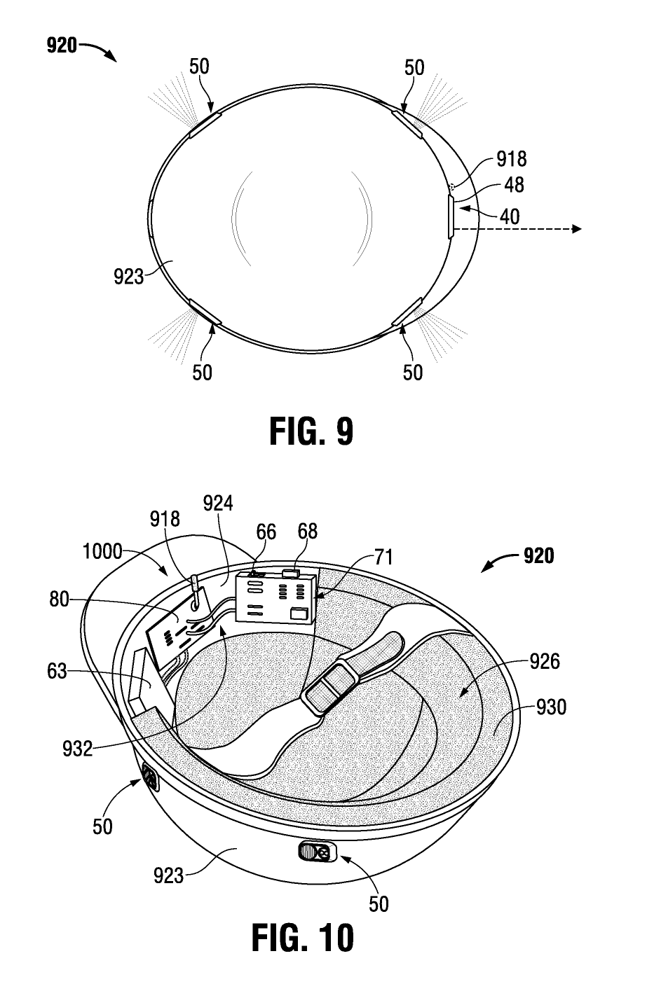

The helmet 20 may include a microphone or other audio input device for audio recording. Preferably, the microphone is oriented to capture all audible sounds, conversations and the like that occur in the vicinity of the officer. In the illustrative embodiment shown in FIG. 2, a microphone 18 is located on the helmet 20 to be positioned above the right eye of the law-enforcement officer when the helmet 20 is worn. The microphone 18 may be adapted to be locatable as desired by the officer. In some embodiments, the microphone 18 is a wireless microphone (e.g., a microphone element and transmitter in one unit) and the base transmitter component 800 may include a receiver for receiving radio signals sent from the transmitter. Additionally, or alternatively, a microphone (e.g., microphone 48 as shown in FIG. 9) may be associated with the housing 41 of the camera module 40. Additionally, or alternatively, a microphone (e.g., microphone 918 as shown in FIGS. 9-11) may be located under the visor of the helmet. In some embodiments, the safety light system 10 may be adapted to allow the camera to be disabled manually by the officer for personal privacy reasons. The amount of time the camera is disabled may be limited and may be monitored and/or recorded, even though the camera is not recording. This option may be made available for use by the officer when video recording would be inappropriate, e.g., restroom breaks.

FIG. 5 shows two light-emitting modules 50 disposed on opposing sides of the rear portion of the helmet 20. The number, size, shape and location of the camera module 40 and the light-emitting modules 50 may be varied from the configuration depicted in FIGS. 1, 2 and 5. For example, an integrated rear camera module may additionally, or alternatively, be incorporated into the helmet 20. One or more camera modules having multiple cameras focused in different directions may be utilized. The one or more camera modules 40 and/or the one or more light-emitting modules 50 may be integrated into the helmet 20, or retrofit to the helmet. As shown in FIG. 5, the helmet 20 may include an edge member 25 configured to cover the lower edge of the shell 23.

The camera module 40 may include an integrated camera (e.g., camera 1544 as shown in FIG. 15) or wireless camera. In some embodiments, wherein the camera module 40 includes a wireless camera, the transmission of camera signals may be carried out on an encrypted basis to provide confidentiality, integrity and authenticity of the information transferred, and preventing disclosure of their contents if the electronic transmission is intercepted.

In FIG. 6, the light-emitting module 50 is shown and includes a housing 51, one or more light sources, and a cover element 57 slidably coupled to the housing 51. In some embodiments, as shown for example in FIG. 6, the light-emitting module 50 includes two LEDs L₁ and L₂. The LEDs L₁ and L₂ may be color-changeable LEDs and/or the intensity of the LED illumination may be controllable. In some embodiments, the light-emitting module 50 may include first and second blue LEDs L₁ and L₂. In some embodiments, the light-emitting module 50 may include first and second amber LEDs L₁ and L₂. Those skilled in the art will recognize that other configurations of LEDs (and/or other light sources) are contemplated.

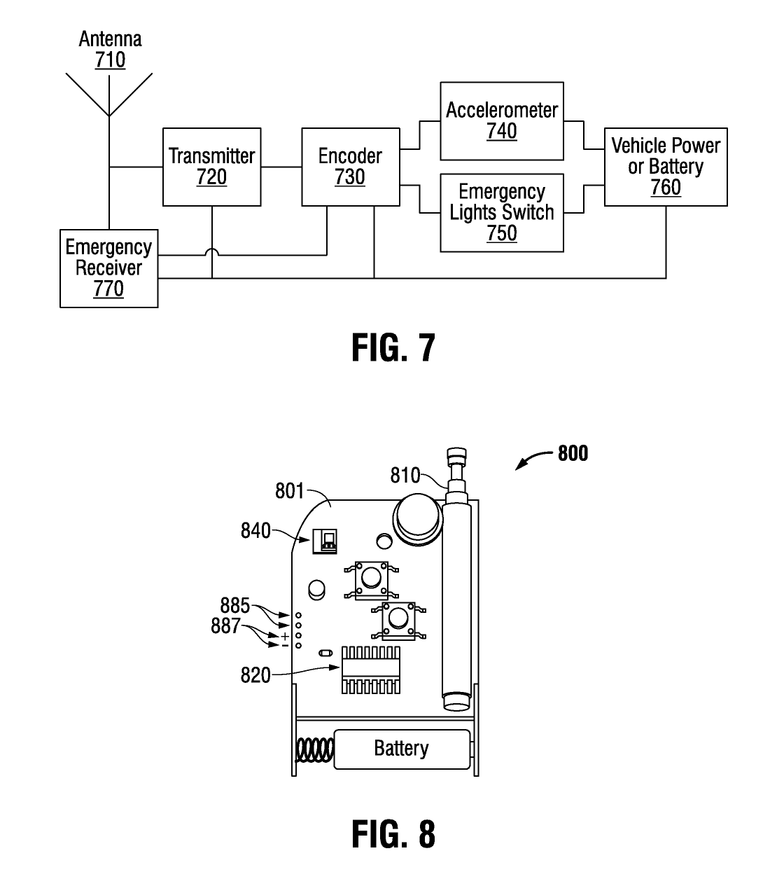

Referring now to FIG. 7, the base transmitter component 800 of the safety light system 10 may be functionally divided into various components. As shown in FIG. 7, the base transmitter component 800 may be conceptualized in six components: a transmitter 720; an encoder 730; an accelerometer 740; an emergency light switch 750; a vehicle power or battery 760; and an emergency receiver 770. The transmitter 720 is coupled to an antenna 710. Using power from the vehicle power or battery 760, the encoder 730 is configured to encode signals from the emergency receiver 770, the accelerometer 740, and/or the emergency light switch 750, and the encoded signals are routed to the transmitter 720. Using power from the vehicle power or battery 760, the transmitter 720 is configured to send signals via the antenna 710.

FIG. 8 shows a printed circuit board 801 including an antenna 810 and a microcontroller 820 for implementing functions of the base transmitter component 800 in accordance with an embodiment of the present disclosure. As seen in FIG. 8, a battery is provided as a power source for the microcontroller 820. Additionally, or alternatively, the base transmitter component 800 may be electrically coupled via the leads 887 to the vehicle power source. In the illustrative embodiment shown in FIG. 8, the base transmitter component 800 includes an accelerometer 840. The base transmitter component 800 may include a radio frequency (RF) module for RF communication with a helmet receiver system in accordance with the present disclosure (e.g., helmet receiver system 1100 shown in FIG. 10 and helmet receiver system 1500 shown in FIG. 15) and/or an emergency flashing lights IC capable of sending a signal to turn on helmet lights. The base transmitter component 800 may additionally, or alternatively, include a camera processor IC capable of processing data from the camera 1544 and/or an encryption IC capable of protecting data by means of data encryption. The base transmitter component 800 may additionally, or alternatively, include an accelerometer capable of measuring impact force and sending data to a recorder and/or an alert IC capable of sending an alert to the RF module when accelerometer records force. In some embodiments, the base transmitter component 800 may include an STG P3.0 processor, or other processor. In some embodiments, for example as shown in FIG. 8, the base transmitter component 800 includes two leads 885 for connection to one or more components of the motorcycle 15 (e.g., emergency light switch 17 as shown in FIG. 1). It is to be understood that the base transmitter component 800 may include a plurality of connection points to connect PCB 801 to peripheral components, such as, for example, LED harness, camera, microphone, battery, etc.

FIGS. 9 and 10 show a helmet 920 in accordance with an embodiment of the present disclosure. The helmet 920 is similar to the helmet 20 of FIG. 1, and description of the like elements is omitted in the interest of brevity. The helmet 920 generally consists of a shell 923 constructed of a rigid material. In the illustrative embodiment shown in FIG. 9, the helmet 920 includes a camera module 40 and four light-emitting modules 50 attached to or otherwise associated with the shell 923. The number, size, shape and location of the camera module 40 and the light-emitting modules 50 may be varied from the configuration depicted in FIGS. 9 and 10.

The helmet 920 includes a cavity 926 defined by the shell 923. A foam element 930 is disposed within the cavity 926. In sonic embodiments, the foam element 930 may be formed using expanded polystyrene (EPS), expanded polypropylene (EPP), GECET® foam as developed by GENERAL ELECTRIC®, expanded polyurethane, and other forms of beaded or unbeaded materials that are used to form crushable materials that, when impacted, distribute force while protecting a wearer of the helmet 920. Those skilled in the art will recognize that other materials may be used to form the foam element 930. In some embodiments, as shown for example in FIG. 10, the foam element 930 includes a “cutout” portion 932 that exposes a portion 924 of the inner surface of the shell 923, e.g., to facilitate attachment of a helmet receiver system. In other embodiments, the foam element (e.g., foam element 1230 shown in FIG. 12) may be configured to substantially cover the entire inner surface area of the shell. The size, shape and location of the “cutout” portion 932 may be varied from the configuration depicted in FIG. 9.

In the illustrative embodiment shown in FIG. 10, the helmet receiver system 1000 includes a portable power source 63, a printed circuit board (PCB) 80, a microphone 918 operably associated with the PCB 80, and a controller 71 including a port 68 and switch 66. Preferably the portable power source 63 is a rechargeable battery or battery pack. In the preferred embodiment, the portable power source 63 is a lithium-ion polymer battery. Those skilled in the art will recognize that other portable power sources are contemplated. The helmet 920 may be adapted to allow the portable power source 63 to be removable. It is to be understood that the lines indicative of wires between various components of the helmet receiver system 1000 are merely illustrative and non-limiting examples of electrical connections, and that helmet receiver system embodiments of the present disclosure may utilize many different configurations of electrical connections, some with additional, fewer, or different electrical connections than depicted in FIG. 10. The helmet receiver system 1000 may be adapted to automatically turn on the camera module 40 when the helmet 920 is in proximity to the vehicle (e.g., motorcycle 15 shown in FIG. 1) and/or the base transmitter component 800. In this regard, the helmet 920 and/or the base transmitter component 800 may include sensors, transceivers, transmitters and/or receivers adapted to obtain proximity data indicative the helmet 920 is in proximity to the vehicle. Additionally, or alternatively, the base transmitter component 800 may be adapted to continuously transmit a camera activation signal, e.g., receivable by a receiver of the helmet receiver system 1000 when the receiver is within a predetermined range (e.g., operating range) of the base transmitter component 800.

In some embodiments, the base transmitter component 800 is adapted to maintain continual two-way communication via Bluetooth/RF with the helmet receiver system 1000, whereby the helmet receiver system 1000 and the base transmitter component 800, when in proximity to each other, will continually transmit and receive activation and deactivation signals from either or both units, thereby continually rechecking function status and/or resending the appropriate signal to ensure the proper functionally of the helmet receiver system 1000 and the base transmitter component 800. This implementation will minimize or eliminate the possible failure of the helmet receiver system 1000 and/or the base transmitter component 800 to receive a desired signal, as the signal is continually sent.

The helmet receiver system 1000 may additionally, or alternatively, be adapted to automatically turn on the camera module 40 when the emergency lights on the vehicle are turned on. In some embodiments, the controller 71 is adapted to activate one or more light-emitting modules 50 responsive to either or both of a signal received from the base transmitter component 800 indicative of activation of the emergency lights switch on a vehicle (e.g., motorcycle 15 as shown in FIG. 1) and a signal indicative that the helmet is in proximity to the vehicle.

The PCB 80 may include any combination of the following components: a radio frequency module for RF communication with base transmitter component 800; an emergency flashing lights IC capable of activating light-emitting modules 50 to produce a flashing light pattern around the helmet 920; connection points to connect PCB 80 to peripheral components; peripheral components, e.g., LED harness, camera, microphone, battery, etc.; camera processor IC capable of processing data from the camera; an encryption IC capable of protecting data by means of data encryption; an accelerometer capable of measuring impact force and sending data to a recorder; an alert IC capable of sending an alert to the RF module when accelerometer records force; and/or an STG P3.0 processor, or other processor.

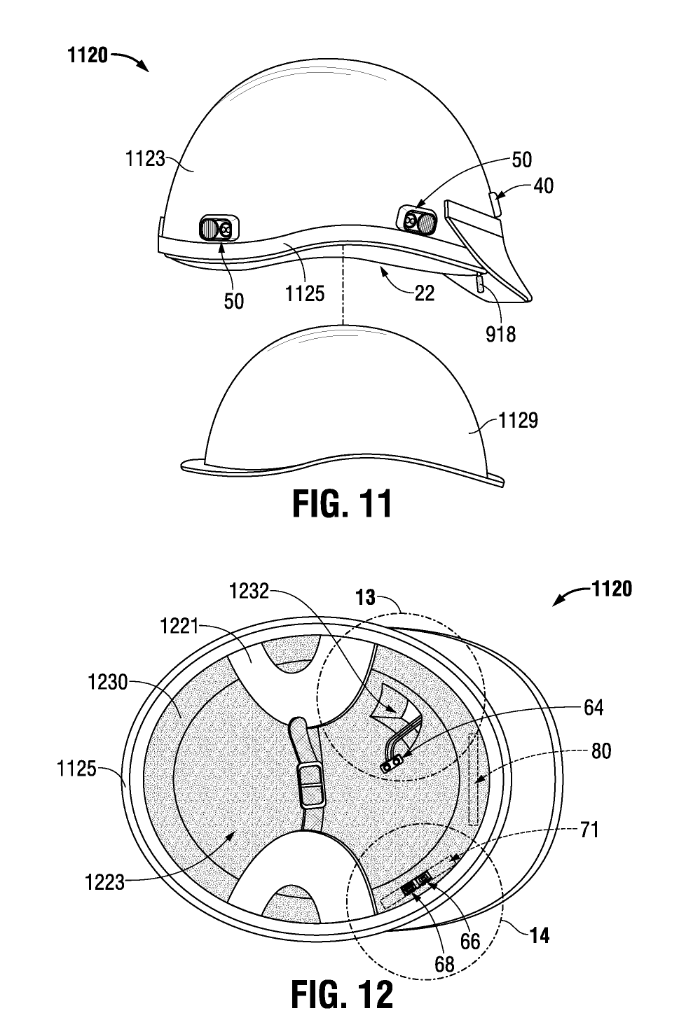

FIGS. 11 and 12 show a helmet 1120 in accordance with an embodiment of the present disclosure. The helmet 1120 includes a camera module 40 and a plurality of light-emitting modules 50. The size, shape and location of the camera module 40 and the light-emitting modules 50 may be varied from the configuration depicted in FIG. 11. The helmet 1120 may include an audio input device (e.g., microphone 18 as shown in FIG. 2) for audio recording.

The helmet 1120 generally consists of a shell 1123 constructed of a rigid material. The shell 1123 may preferably be contoured and includes a bottom opening 1122 such that the shell 1123 is configured to fit over the head of a user (e.g., operator “P” of the motorcycle 15 shown in FIG. 1). The helmet 1120 includes a cavity 1126 defined by the shell 1123 and a foam element 1130 disposed within the cavity 1126. The helmet 1120 may include a helmet liner 1129 formed of a rigid material (e.g., plastic) and configured to fit onto the foam element 1130. The foam dement 1130 may be any form of beaded or unheaded materials that are used to form crushable materials that, when impacted, distribute force while protecting a wearer of the helmet 1120. Those skilled in the art will recognize that other materials may be used to form the foam element 1130 and the helmet liner 1129. In some embodiments, the helmet 1120 may include an edge member 1125 configured to cover the lower edge of the shell 1123 of the helmet 1120.

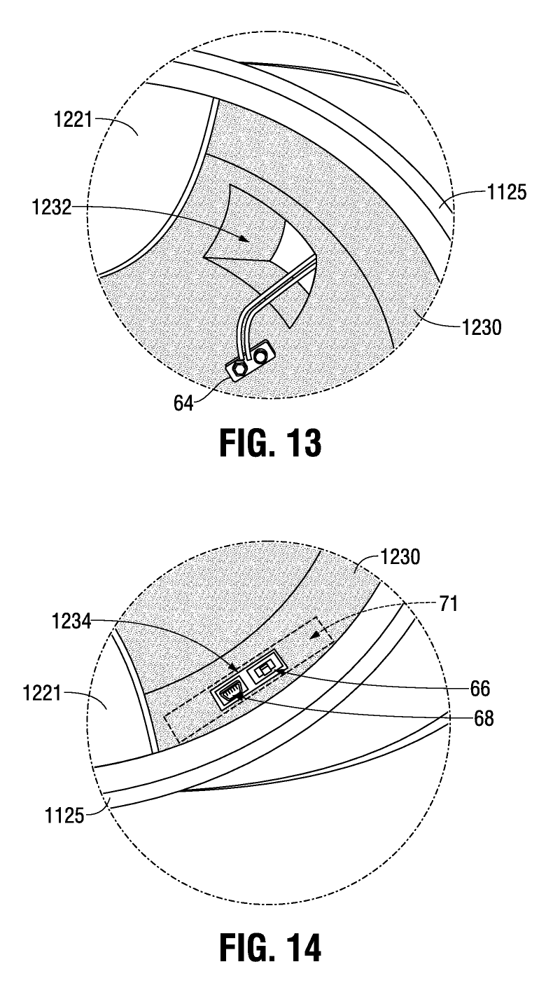

As best seen in FIG. 13, the foam element 1130 includes a first cutout 1232 configured to allow attachment of a portable power source (e.g., a lithium-ion polymer battery) to the connector 64. In the illustrative embodiment shown in FIG. 14, the foam element 1130 includes a second cutout 1234 configured to expose the port 68 and the switch 66. The helmet 1120 is similar to the helmet 920 of FIG. 10, except for the connector 64 and the first and second cutouts 1232, 1234, and description of the like elements is omitted in the interest of brevity.

FIG. 15 shows a helmet receiver system 1500 in accordance with an embodiment of the present disclosure. The helmet receiver system 1500 includes a portable power source 1563, a controller 1571 connected via wires 1561, 1562 to the portable power source 1563, a storage device 1563, a camera 1544 connected via a ribbon cable 1574 to the controller 1571, and an antenna 1572. The portable power source 1563 and the controller 1571 are similar to the portable power source 63 and the controller 71, respectively, of FIG. 10. Further description of the like elements is omitted in the interest of brevity.

The storage device 1576 may he removable or non-removable. The storage device 1576 may be a removable memory card, e.g., SanDisk flash memory card, etc. The camera 1544 may include complementary metal oxide semiconductors (CMOS) image sensors, a charge-coupled device (CCD) image sensor, and/or other sensor. Preferably, the camera 1544 is a high definition (HD) camera. In the preferred embodiment, the camera 1544 is a waterproof, high-definition (HD) digital camera. Those skilled in the art will recognize that other cameras are contemplated, e.g., still image cameras, infrared cameras, black and white cameras, etc. The helmet receiver system 1500 may he adapted to automatically turn on the camera 1544 when the emergency lights on the vehicle (e.g., motorcycle 15 shown in FIG. 1) are turned on. The helmet receiver system 1500 may additionally, or alternatively, he adapted to automatically turn on the camera 1544 when the helmet is in proximity to the vehicle.

In some embodiments, the helmet receiver system 1500 may be adapted to automatically turn on a microphone or other audio input device associated with helmet when the emergency lights on the vehicle (e.g., motorcycle 15 shown in FIG. 1) are turned on. In some embodiments, the helmet receiver system 1500 may be adapted to automatically turn on a microphone or other audio input device associated with helmet when the helmet is in proximity to the vehicle. In other embodiments, the helmet receiver system 1500 may be adapted to automatically turn on the camera 1544 and a microphone (e.g., microphone 18 as shown in 2, and microphone 48 as shown in FIG. 9) responsive to a signal indicative of activation of emergency lights on the vehicle.

In operation, the helmet (e.g., helmet 20 shown in FIG. 1, helmet 920 shown in FIG. 9, and helmet 1120 shown in FIG. 11) may be placed over the head of the user and secured thereto via the chin strap. The camera 1544 of the helmet receiver system 1500 may be activated when the emergency lights on the law-enforcement officer's vehicle (e.g., motorcycle, bicycle, powered bicycle, etc.) are turned on. The camera 1544 may additionally, or alternatively, be activated when the helmet is in proximity to the officer's vehicle, equestrian saddle, etc. The camera 1544 may additionally, or alternatively, be activated by a switch 66. Images captured by the camera 1544 are stored on the storage device 1576. In some embodiments, images captured by the camera 1544 may be downloaded via the port 68.

During operation of the safety light system 10, using power from a portable power source 63, 1563 the helmet receiver system 1000, 1500 intercepts commands from the base transmitter component 800 causing the helmet receiver system 1000, 1500 to perform one or more of its functions. When an operator P of the motorcycle 15 activates the emergency lights switch 750 (e.g., toggles a switch, depresses a button, etc.) a signal is sent to the encoder 730. Using power from the vehicle power or battery 760, the encoder 730 outputs a signal indicative of the emergency lights activation to the transmitter 720. The transmitter 720 sends the signal via the antenna 710. The helmet receiver system receives the signal from the antenna 1572 and activates the light-emitting modules 50. In some embodiments, the helmet receiver system is adapted to he capable of sending signals to the base transmitter component 800.

In some embodiments, using power from the vehicle power or battery 760, the encoder 730 encodes signals from the accelerometer 740 and outputs a signal indicative of a rapid deceleration to the transmitter 720. The transmitter 720 sends the signal via the antenna 710. The helmet receiver system 1000, 1500 receives the signal from the antenna 1572 and activates the light-emitting modules 50 and/or the camera 1544. In some embodiments, the helmet receiver system 1000, 1500 may activate a cellular phone (and/or other communication device) to send an alert. In some embodiments, when the helmet experiences forceful impact, the helmet receiver system 1000, 1500 sends a signal to the motorcycle 15 activating the motorcycle emergency lights, and may activate the officer's cellular phone's GPS, and/or the officer's cellular phone calls dispatch/motorcade official with a prerecorded message such as “officer requires immediate assistance” and/or summons emergency aid, e.g., an ambulance, Life Flight emergency rescue, etc.

Helmets in accordance with embodiments of the present disclosure may include any number of cameras and/or camera modules, microphones, and/or light modules arranged in any suitable configuration. Helmets with an integrated camera and safety light systems including the same in accordance with the present disclosure may include any combination of features of the helmet embodiments and helmet receiver system embodiments described herein.

Although embodiments have been described in detail with reference to the accompanying drawings for the purpose of illustration and description, it is to be understood that the disclosed processes and apparatus are not to be construed as limited thereby. It will be apparent to those of ordinary skill in the art that various modifications to the foregoing embodiments may be made without departing from the scope of the disclosure.

What is claimed is:

1. A helmet adapted to be wearable by an operator of a motor vehicle, the helmet comprising:
a shell;
a camera module associated with the shell, wherein the camera module includes a housing and a camera;
at least one light-emitting module associated with the shell; and
a controller adapted to activate the at least one light-emitting module responsive to a signal indicative of activation of emergency lights on the motor vehicle.

2. The helmet of claim 1, wherein the controller is further adapted to activate the camera responsive to a signal indicative that the helmet is in proximity to the motor vehicle.

3. The helmet of claim 1, further comprising a portable power source, wherein the controller is electrically coupled to the portable power source.

4. The helmet of claim 3, wherein the shell defines a cavity therein configured to house the portable power source.

5. The helmet of claim 1, wherein at east one of the at least one light-emitting module includes first and second blue LEDs.

6. The helmet of claim 1, wherein at least one of the at least one light-emitting module includes first and second amber LEDs.

7. The helmet of claim 1, further comprising a microphone.

8. The helmet of claim 7, wherein the controller is further adapted to activate the microphone responsive to a signal indicative that the helmet is in proximity to the motor vehicle.

9. The helmet of claim 7, wherein the controller is further adapted to activate the microphone responsive to a signal indicative of activation of emergency lights on the motor vehicle.

10. The helmet of claim 1, wherein the camera module further includes a microphone.

11. The helmet of claim 10, wherein the controller is further adapted to activate the camera and the microphone responsive to a signal indicative of activation of emergency lights on the motor vehicle.

12. A safety light system, comprising:
a base transmitter component communicatively coupleable with one or more system components of a motor vehicle, wherein the one or more system components include an emergency lights switch;
a helmet adapted to be wearable by a motor vehicle operator;
a plurality of light-emitting modules associated with the helmet;
a camera module associated with the helmet, wherein the camera module includes a housing and a camera; and
a helmet receiver system, wherein the helmet receiver system includes:
an antenna and a controller adapted to activate one or more of the plurality of light-emitting modules responsive to a signal received from the base transmitter component indicative of activation of the emergency lights switch on the motor vehicle.

13. The safety light system of claim 12, wherein the controller is further adapted to activate the camera responsive to a signal indicative that the helmet is in proximity to the motor vehicle.

14. The safety light system of claim 12, wherein the helmet further includes a portable power source, and wherein the controller is electrically coupled to the portable power source.

15. The safety light system of claim 12, wherein the helmet includes a shell defining a cavity therein, and wherein the helmet receiver system is contained within the cavity.

16. The safety light system of claim 12, further comprising a. microphone associated with the helmet.

17. The safety light system of claim 16, wherein the controller is further adapted to activate the microphone responsive to a signal indicative that the helmet is in proximity to the motor vehicle.

18. The safety light system of claim 12, wherein the camera module further includes a microphone associated with the housing.

19. The safety light system of claim 18, wherein the controller is further adapted to activate the camera and the microphone responsive to a signal indicative of activation of emergency lights on the motor vehicle.
